(19) United States
(12) Patent Application Publication
(10) Pub. No.: US 2006/0220463 A1
(43) Pub. Date: Oct. 5, 2006

(54) Hot-pluggable computer power supplies

(76) Inventors: Raoji A. Patel, Round Rock, TX (US); Robert A. Guenther, Pepperell, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/098,172

(22) Filed: Apr. 4, 2005

(51) Int. Cl. H02J 1/04

(52) U.S. Cl. 307/60

(57) ABSTRACT

In a computer system having redundant removable power supply modules, a power supply module comprises a voltage output and a signal input. At the voltage output, a voltage is supplied to components of the computer system. At the signal input, a module present signal is received from another power supply module. When the module present signal received from the other power supply module is asserted, the voltage is supplied at a nominal voltage. Upon deassertion of the module present signal received from the other power supply module, the voltage is increased to a maximum voltage.

### BACKGROUND

A computer system that has to be on all the time may have two redundant hot-pluggable power supplies to supply electrical power to the components of the computer system. Under normal operating conditions, both power supplies work together to supply the electrical power for the computer system. Thus, each power supply generates half of the total power required by the computer system. When one of the power supplies fails or is removed from the computer system, then the remaining power supply generates the entire amount of the power for the computer system. In this manner, the computer system is ensured to operate almost all the time, even if one of the power supplies should fail.

During normal operation, each power supply generates its share of the required electrical power at the same voltage level as the other power supply. Upon failure or removal of one of the power supplies, the remaining power supply quickly increases its power output. The sudden increase in the remaining power supply's power output causes a momentary drop in the output voltage level of the power supply. A number of filter capacitors is included across the output to prevent the output voltage level from dropping below a minimum required voltage level at which the components of the computer system can continue to operate without interruption. The filter capacitors take up valuable space within the computer system and add cost to the computer system.

### BRIEF DESCRIPTION OF THE DRAWINGS

FIG. 1 is a top, front, left side perspective view of a computer system incorporating an embodiment of the present invention.

FIG. 2 is a simplified schematic diagram of the computer system shown in FIG. 1 with redundant power supply modules according to an embodiment of the present invention.

FIG. 3 is a simplified schematic diagram of the computer system shown in FIG. 1 with one of the redundant power supply modules removed according to an embodiment of the present invention.

### DETAILED DESCRIPTION

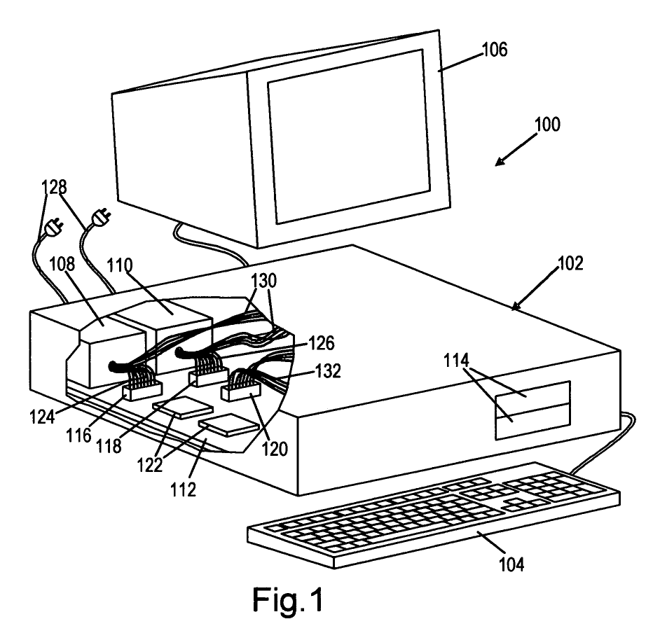

A computer system 100 incorporating an embodiment of the present invention is shown in FIG. 1 having elements such as a housing 102, a keyboard 104 and a display 106. Among the other components within the housing 102, the computer system 100 includes multiple redundant, removable and hot-pluggable power supply modules 108 and 110. The power supply modules 108 and 110 enable the computer system 100 to have fewer and/or smaller filter capacitors to prevent the output voltage of the power supply modules 108 and 110 from decreasing below the minimum required voltage level for operation of components of the computer system 100 upon removal of one of the power supply modules 108 or 110. Although the present invention is described with respect to its use in the computer system 100, it is understood that the invention is not so limited, but may be used in any appropriate electronic system that includes redundant power supplies, regardless of any other elements included in the electronic system.

The computer system 100 also includes within the housing 102 a printed circuit board (PCB) 112 and various peripheral devices 114. The PCB 112 includes various connectors (e.g. 116, 118 and 120) and electronic components (e.g. 122). Some of the connectors 116 and 118 connect the PCB 112 to the power supply modules 108 and 110 via wires or cables 124 and 126, respectively.

The power supply modules 108 and 110 receive AC power through power cables 128 and convert the AC power into appropriate electrical power for the components 122 and devices 114. The power supply modules 108 and 110 supply the electrical power to the various components 122 on the PCB 112 through the wires or cables 124 and 126, the connectors 116 and 118 and various electrical traces on the PCB 112. The power supply modules 108 and 110 also supply electrical power through additional wires or cables 130 to some of the devices 114 that are not mounted on the PCB 112. Additionally, others of the devices 114 may receive electrical power from the power supply modules 108 and 110 through the PCB 112, the connector 120 and additional wires or cables 132. Each power supply module 108 and 110 supplies half the power requirements of the computer system 100 when both of the power supply modules 108 and 110 are installed within the computer system 100 and operational. When either of the power supply modules 108 or 110 fails to operate or is removed from the housing 102, then the remaining power supply module 108 or 110 generates and supplies the total power requirements of the computer system 100, or of the components 122 and the devices 114.

The power supply modules 108 and 110 are mounted within the housing 102 by any appropriate means, such as by being attached to the rear wall of the housing 102 by mounting screws or other means. The power supply module 108 or 110 can be removed from the housing 102 by disconnecting its power cable 128, disconnecting the wires or cables 124 or 126, detaching the power supply module 108 or 110 from its mounting means and pulling the power supply module 108 or 110 out of the housing 102. Another power supply module 108 or 110 may be inserted into the housing 102 by reversing this procedure.

The power supply modules 108 and 110 are “hot-pluggable,” which means that either of the power supply modules 108 or 110 can be removed from and replaced into the housing 102 of the computer system 100 while the computer system 100 is operational. Removal and replacement of either power supply module 108 or 110, while the computer system 100 is operational, may be performed as long as the other power supply module 108 or 110 is functioning properly and can supply the computer system 100 with its entire power requirement. Therefore, when one of the power supply modules 108 or 110 fails or is removed during the operation of the computer system 100, the other of the power supply modules 108 or 110 quickly increases its power output to satisfy the entire power requirement of the computer system 100. This rapid power increase can cause the voltage output of the remaining power supply module 108 or 110 to momentarily decrease, but the voltage output soon returns to its prior value.

The components 122 and devices 114 typically have specified power, current and voltage requirements in order to operate properly. Typically, the components 122 and devices 114 have a specified nominal voltage at which they are intended to operate. Additionally, the components 122 and devices 114 also have a specified minimum voltage, below the nominal voltage, below which they are not intended to operate, even for the short duration of the momentary decrease of the voltage output of the remaining power supply 108 or 110. For ease of description, the following embodiments will be described with reference primarily only to the components 122.

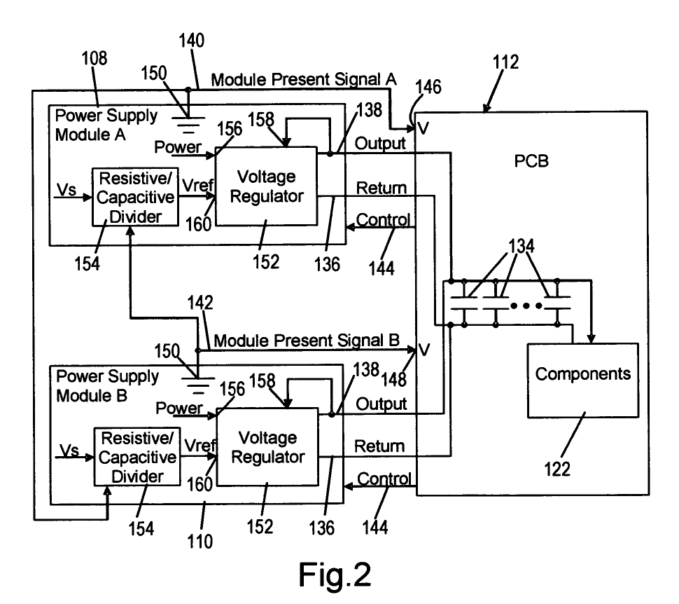

One or more filter capacitors 134 (FIG. 2) prevent the momentary decrease of the voltage output of the remaining power supply module 108 or 110 upon failure or removal of the other power supply module 108 or 110 from decreasing below the specified minimum voltage of the components 122. The return signals 136 and output signals 138 of the power supply modules 108 and 110 are effectively connected together in parallel in order to add their power outputs together. The filter capacitors 134, therefore, are placed across the return signals 136 and output signals 138. In the embodiment shown, the filter capacitors 134 are placed across the outputs of the power supply modules 108 and 110 at a point in the circuitry on the PCB 112. Alternative embodiments may locate the filter capacitors 134 within the power supply modules 108 and 110 or at any appropriate point between the power supply modules 108 and 110 and the PCB 112. Additionally, for the other devices 114, the filter capacitors 134, if needed, may be placed at any appropriate point within the other devices 114, within the power supply modules 108 and 110 or in between.

The total capacitance of the filter capacitors 134 is dependent on, among other parameters, the difference between the minimum voltage below which the components 122 are not intended to operate and the output voltage of the power supply modules 108 and 110 immediately prior to the momentary decrease due to the failure or removal of one of the power supply modules 108 or 110. A larger difference in these voltages results in a lower required total capacitance of the filter capacitors 134. Therefore, a larger difference in these voltages results in the ability to use fewer and/or smaller filter capacitors 134 in order to prevent the output voltage of the power supply modules 108 and 110 from decreasing below the minimum voltage. The use of fewer and/or smaller filter capacitors 134 results in cost and space savings in the computer system 100.

According to an embodiment of the present intention, the output voltage of the remaining power supply module 108 or 110 is increased above the nominal voltage at which the components 122 are intended to operate following the failure or removal of the other power supply module 108 or 110. The increased voltage level of the output voltage is referred to herein as a maximum voltage. The increase in the voltage level of the output voltage of the remaining power supply module 108 or 110 results in there being a larger difference between the output voltage of the remaining power supply module 108 or 110 and the minimum voltage than there would be if the output voltage remained at the nominal voltage. Therefore, according to various embodiments, cost and space savings are realized with respect to the filter capacitors 134, since the required number and/or size of the filter capacitors 134 is lower than that required if the output voltage were not increased due to the greater difference between the maximum voltage and the minimum voltage.

A formula for determining the number of a particular given type of filter capacitors 134 to be used in a given situation is as follows:

$$N = \frac{ESRofthecapacitor * currentloadchange}{V max - V min} ,$$

where N is the number of the given type of filter capacitors 134, ESRofthecapacitor is the equivalent series resistance of the given type of filter capacitors 134, currentloadchange is the change in the amount of current that the remaining power supply module 108 or 110 undergoes upon increasing its output power to satisfy the entire power requirement for the computer system 100, Vmax is the maximum voltage to which the output voltage is increased and Vmin is the minimum voltage below which the components 122 are not intended to operate. If this formula results in a number with a fraction, then the next higher whole number may be used. For this formula, an appropriate available capacitor, for which the equivalent series resistance and the capacitance are known, is chosen for the filter capacitors 134. The total capacitance of the filter capacitors 134 is, therefore, the known capacitance of one of the given type of filter capacitors 134 multiplied by the number N. The current load change and minimum voltage are determined by the components 122 and the design of the computer system 100. The maximum voltage is selected to be an appropriate amount above the nominal voltage and which will not adversely affect the operation of the components 122. Since the difference between the maximum and minimum voltages is in the denominator of the formula, a larger maximum voltage will result in a smaller number of the filter capacitors 134.

Each power supply module (A and B) 108 and 110 includes, among other signals in the wires or cables 124 and 126 (FIG. 1), a module present signal (module present signal A 140 and module present signal B 142) and various control signals 144 in addition to the return signal 136 and the output signal 138. The module present signals 140 and 142 indicate whether the associated power supply module 108 or 110 is present and operational in the computer system 100. The module present signals 140 and 142 are, thus, supplied to inputs 146 and 148 on the PCB 112 to indicate to the computer system 100 (e.g. to one of the components 122) whether the power supply modules 108 and 110 are installed and operational. The inputs 146 and 148 are held to a voltage V. In the power supply modules 108 and 110, the module present signals 140 and 142 are grounded at 150. Therefore, when either power supply module 108 or 110 is installed and operational, its module present signal 140 or 142 pulls the input voltage V at the input 146 or 148 to ground, thereby signaling to the computer system 100 that the power supply module 108 or 110 is installed and operational. The module present signals 140 and 142 are, thus, asserted when the input voltage V at the inputs 146 and 148 is grounded. On the other hand, the module present signals 140 and 142 are deasserted when the input voltage V at the inputs 146 and 148 is not grounded.

The control signals 144 control the operation of the power supply modules 108 and 110. For example, when the module present signals 140 and 142 are asserted, the control signals 144 indicate to each power supply module 108 and 110 to supply half of the power requirements of the computer system 100. On the other hand, when one of the module present signals 140 or 142 is deasserted, indicating that its associated power supply module 108 or 110 has failed or been removed, the control signal 144 to the remaining power supply module 108 or 110 indicates to the remaining power supply module 108 or 110 to supply the entire power requirements of the computer system 100.

Each power supply module 108 and 110 generally includes, among other components, a voltage regulator 152 and a resistive/capacitive divider 154. (The resistive/capacitive divider 154 may be incorporated in the voltage regulator 152.) The voltage regulator 152 generates the output voltage at the output signal 138 from an appropriate power input at 156. The voltage regulator 152 receives feedback of the output voltage at 158. The voltage regulator 152 compares the output voltage feedback with a reference voltage (Vref) received at 160. The Vref is created by the resistive/capacitive divider 154 from an appropriate source voltage (Vs). Under normal operating conditions, the Vref is the nominal voltage for the power supply module 108 or 110.

The resistive/capacitive divider 154 receives the module present signal 140 or 142 in addition to the Vs. Under normal operating conditions, i.e. both power supply modules 108 and 110 are present and operational, the module present signals 140 and 142 are grounded. In this case, the ground on the module present signals 140 and 142 causes the resistive/capacitive dividers 154 to create the Vref at the nominal voltage, so the voltage regulators 152 generate the output voltage at the nominal voltage for powering the computer system 100.

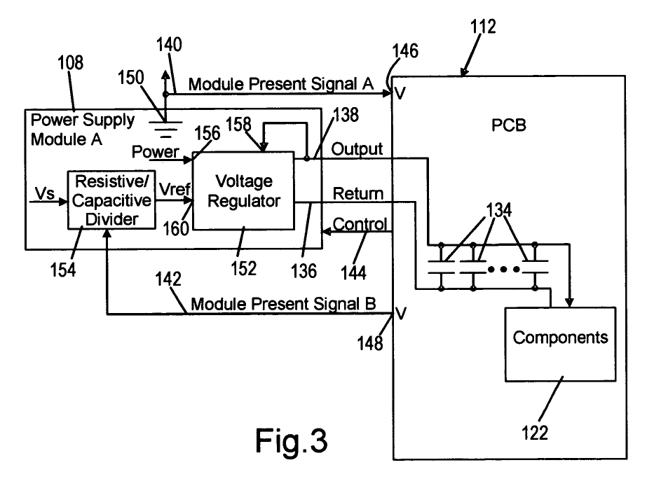

When one of the power supply modules (e.g. 110) fails or is removed, the module present signal 142 received by the remaining power supply module 108 is driven to the voltage V supplied at input 148 of the PCB 112, as shown in FIG. 3. In this case, the voltage V on the module present signal 142 causes the resistive/capacitive divider 154 to create the Vref at the maximum voltage, so the voltage regulator 152 generates the output voltage at the maximum voltage for powering the computer system 100.

Since the output voltage of the remaining power supply module 108 is increased upon failure or removal of the other power supply module 110, the momentary decrease of the output voltage of the remaining power supply module 108 will occur from the maximum voltage, rather than from the nominal voltage. Therefore, the voltage difference in the denominator of the above formula is based on the maximum voltage, rather than on the nominal voltage, so the voltage difference is larger than it would be if the output voltage of the remaining power supply module 108 were not increased upon failure or removal of the other power supply module 110. Consequently, the required number of filter capacitors 134 is smaller than it would be if the output voltage of the remaining power supply module 108 were not increased.

The capacitive characteristics of the resistive/capacitive divider 154 form an RC time constant in the resistive/capacitive dividers 154 that causes the Vref to decay from the maximum voltage to the nominal voltage over a period of time. In this manner, the power supply modules 108 and 110 will generate the maximum voltage only temporarily, so the output voltage returns to the nominal voltage. The RC time constant is selected so that the decay of the Vref will not allow the momentary decrease of the output voltage to drop below the minimum voltage. Therefore, the changes in the output voltage due to both the Vref change and the momentary decrease are temporary, so the components 122 will be operated at the nominal voltage with only a temporary fluctuation upon failure or removal of one of the power supply modules 108 and 110.

According to an alternative embodiment, a resistor divider is used in place of the resistive/capacitive divider 154. In this case, when the Vref is increased to cause the voltage regulator 152 to generate the maximum voltage, the Vref does not decay back to the nominal value. Instead, the Vref remains at the increased value, causing the voltage regulator 152 to continue to generate the maximum voltage. When this situation occurs due to removal of one of the power supply modules 108 or 110, ordinarily a replacement power supply module 108 or 110 will be inserted into the computer system 100 within a matter of minutes. At this point, the module present signal 140 or 142 is reasserted, so the Vref and the output voltage return to the nominal value. Therefore, the components 122 will operate at the maximum voltage for only a few minutes.

We claim:

1. A computer system comprising:
first and second hot-pluggable power supplies, each power supply asserting a signal indicating that it is present in the computer system, each power supply receiving the signal from the other power supply, each power supply maintaining an output voltage at a nominal voltage in response to assertion of the signal from the other power supply, each power supply increasing the output voltage to a maximum voltage in response to deassertion of the signal from the other power supply.

2. A computer system as defined in claim 1 further comprising:
electronic components having a total power requirement, a nominal voltage requirement and a minimum voltage requirement;
and wherein:
the power supplies supply power to the electronic components according to the total power requirement and the nominal voltage requirement;
each power supply supplies a portion of the total power requirement to the electronic components when both of the power supplies are installed in the computer system;
each power supply is capable of supplying the total power requirement to the electronic components when the other power supply is removed from the computer system; and
each power supply increases the output voltage at which the power is supplied above the nominal voltage upon removal of the other power supply from the computer system.

3. A computer system as defined in claim 1 wherein:
for each power supply, the signal asserted thereby is deasserted upon removal of the power supply from the computer system.

4. A computer system as defined in claim 1 further comprising:
an electronic component;
and wherein:
for each power supply, the signal asserted thereby is supplied to the electronic component to indicate that the power supply is present in the computer system.

5. A computer system as defined in claim 1 further comprising:
at least one filter capacitor across the output voltage of the power supplies to prevent the output voltage from decreasing below a minimum voltage upon removal of one of the power supplies, capacitance of the at least one filter capacitor depending on a difference between the maximum voltage and the minimum voltage.

6. A computer system as defined in claim 1 wherein:
the increase of the output voltage to the maximum voltage is temporary; and
the output voltage returns to the nominal voltage after a period of time.

7. A computer system comprising:
first and second redundant means for powering components of the computer system;
means for indicating whether each of the powering means is present in the computer system;
means for causing each of the powering means to supply a nominal voltage to the components in response to indication that the other of the powering means is present in the computer system; and
means for causing each of the powering means to generate a maximum voltage, above the nominal voltage, in response to indication that the other of the powering means is not present in the computer system.

8. A computer system as defined in claim 7 wherein:
means for preventing each of the powering means from supplying less than a minimum voltage to the components upon removal of the other of the powering means from the computer system.

9. A power supply module for a computer system having redundant removable power supply modules, comprising:
a voltage output at which a voltage is supplied to components of the computer system; and
a signal input at which a module present signal is received from another power supply module;
and wherein:
when the module present signal received from the other power supply module is asserted, the voltage is supplied at a nominal voltage; and
upon deassertion of the module present signal received from the other power supply module, the voltage is increased to a maximum voltage.

10. A power supply module as defined in claim 9 wherein:
deassertion of the module present signal received from the other power supply module occurs upon removal of the other power supply module from the computer system.

11. A power supply module as defined in claim 9 further comprising:
at least one filter capacitor across the voltage output and which prevents the voltage from subsequently decreasing below a minimum voltage after removal of the other power supply module and the voltage has been increased to a maximum voltage.

12. A power supply module as defined in claim 11 wherein:
capacitance of the at least one filter capacitor depends on a difference between the maximum voltage and the minimum voltage.

13. A power supply module as defined in claim 9 wherein:
the increase of the voltage to the maximum voltage is temporary; and
the voltage returns to the nominal voltage after a period of time.

14. A method of removing a power supply from a computer system having redundant power supplies during operation of the computer system, comprising:
sending a signal from a first power supply to a second power supply indicating that the first power supply is present;
maintaining a voltage output by the second power supply at a nominal voltage in response to assertion of the signal;
removing the first power supply from the computer system to cause deassertion of the signal; and
increasing the voltage output by the second power supply to a maximum voltage in response to deassertion of the signal.

15. A method as defined in claim 14 further comprising:
increasing power output by the second power supply causing the voltage output by the second power supply to temporarily decrease almost to a minimum voltage.

16. A method as defined in claim 15 wherein:
the voltage output by the second power supply is held above the minimum voltage by at least one filter capacitor.

17. A method as defined in claim 14 wherein:
the increasing of the power output by the second power supply is temporary.
